(19) United States
(12) Patent Application Publication
(10) Pub. No.: US 2024/0272518 A1
(43) Pub. Date: Aug. 15, 2024

(54) LENS DRIVE DEVICE AND LENS BARREL EQUIPPED WITH SAME

(71) Applicant: Panasonic Intellectual Property Management Co., Ltd., Osaka (JP)

(72) Inventor: Hiroyasu FUJINAKA, Osaka (JP)

(73) Assignee: Panasonic Intellectual Property Management Co., Ltd., Osaka (JP)

(21) Appl. No.: 18/401,522

(22) Filed: Dec. 31, 2023

(30) Foreign Application Priority Data
Feb. 15, 2023 (JP) 2023-021670

(51) Int. Cl. G03B 3/10; G02B 7/02; H02K 41/035

(52) U.S. Cl. CPC G03B 3/10; G02B 7/021; G02B 7/023; G03B 2205/0069; H02K 41/0354

(57) ABSTRACT

A lens drive device 20 includes a second lens group frame unit 21, an n-phase (n is an integer of 2 or more) coil 23, a plurality of magnets 25, and a plurality of yokes 24. The second lens group frame unit 21 holds a second lens group L2 that is driven in the optical axis AX direction. The coil 23 is provided to the second lens group frame unit 21. The magnets 25 are disposed opposite the coil 23. The yokes 24 have a plurality of magnets 25 that are disposed along the optical axis AX direction so as to sandwich the coil 23, and each have a bent end portion 24c that is disposed along the lengthwise direction and improves rigidity in the lengthwise direction.

### CROSS-REFERENCE TO RELATED APPLICATIONS

This application claims priority to Japanese Patent Application No. 2023-021670 filed on Feb. 15, 2023. The entire disclosure of Japanese Patent Application No. 2023-021670 is hereby incorporated herein by reference.

### BACKGROUND

### Technical Field

The present invention relates to a lens drive device and a lens barrel equipped with the same.

### Description of the Related Art

Linear motors capable of high-speed response have been used in recent years to move the lens frame of a lens barrel in the optical axis direction.

For example, in order to properly fix a coil to a coil holder by adhesive bonding, Patent Literature 1 discloses an actuator in which an air-core coil used in a magnetic drive circuit that vibrates a movable body in a second direction is fixed with an adhesive agent to one side in a first direction of a flat coil holder, facing in the first direction.

Also, in order to generate a large thrust while keeping the height dimension in the axial direction small, Patent Literature 2 discloses a linear actuator in which upper and lower electric coils are wound around a common bobbin, and current is sent in opposite directions through the upper and lower electric coils so as to generate thrust in a common direction.

### CITATION LIST

### Patent Literature

Patent Literature 1: JP-A 2019-180147
Patent Literature 2: JP-A 2008-237004

### SUMMARY

### Problem to be Solved by the Invention

However, the following problems are encountered with the conventional actuators described above.

With the actuator disclosed in Patent Literature 1, although the coil can be properly fixed with an adhesive agent by using a coil holder, the coil holder is disposed so as to be sandwiched between a substantially U-shaped first yoke and a flat second yoke, which increases the number of parts and may also result in an actuator that is larger in size.

Also, the linear actuator disclosed in Patent Literature 2 is configured such that a substantially cylindrical inner yoke and outer yoke are put together, so a problem is that the product tends to end up being larger than with a configuration involving flat yokes.

In particular, the thinner are the yokes included in a linear actuator, the more likely they are to become magnetically saturated, and furthermore, although a thinner yoke does reduce the size of the linear actuator, there is the risk of warping in the lengthwise direction due to magnetic attraction force.

It is an object of the present invention to provide a lens drive device in which the yokes are thin enough to prevent magnetic saturation while ensuring adequate bending strength against magnetic attraction force, and is therefore smaller and lighter, as well as a lens barrel comprising this lens drive device.

### Means for Solving Problem

The lens drive device disclosed herein comprises a lens frame, an n-phase coil (n is an integer of 2 or more), a plurality of magnets, and a plurality of yokes. The lens frame holds a lens that is driven in the optical axis direction. The n-phase coil is provided to the lens frame. The plurality of magnets are disposed opposite the n-phase coil. In the plurality of yokes, the plurality of magnets are provided along the optical axis direction and are disposed so as to sandwich the coil, and each yoke has a reinforcing portion that is provided along the lengthwise direction and improves rigidity in the lengthwise direction.

### (Effects)

With the lens drive device according to the present invention, a reduction in size and weight can be achieved by making the yokes thin enough to prevent magnetic saturation while ensuring adequate bending strength against magnetic attraction force.

### BRIEF DESCRIPTION OF THE DRAWINGS

FIG. 1 is an overall oblique view of the configuration of a lens barrel including the lens drive device according to an embodiment of the present invention;

FIG. 2 is an exploded oblique view of the lens barrel in FIG. 1;

FIG. 3 is an oblique view of the configuration of a lens drive device included in the lens barrel of FIG. 2;

FIG. 4A is a front view of the lens drive device in FIG. 3 as viewed from the subject side in the optical axis direction;

FIG. 4B is a cross-sectional view along the A-A line in FIG. 4A;

FIG. 5 is an oblique view of a yoke and a magnets included in a linear motor that drives a second lens group frame unit in FIG. 3;

FIG. 6 is a front view of the yoke and magnets in FIG. 5 as viewed in the optical axis direction;

FIG. 7 is an oblique view of the second lens group frame unit and the linear motor included in the lens drive device of FIG. 3;

FIG. 8A is a front view of the second lens group frame unit and linear motor in FIG. 7 as viewed from the subject side in the optical axis direction;

FIG. 8B is a cross-sectional view along the B-B line in FIG. 8A;

FIG. 9 is an exploded oblique view of the configuration of the second lens group frame unit included in FIG. 7;

FIG. 10 is an oblique view of the second lens group frame unit and the linear motor included in the lens drive device according to another embodiment of the present invention;

FIG. 11A is an oblique view of a yoke and magnets included in the linear motor that drives the second lens group frame unit in FIG. 10;

FIG. 11B is a front view of the yoke and magnets in FIG. 11A as viewed in the optical axis direction;

FIG. 12 is an oblique view of the second lens group frame unit and the linear motor included in a lens drive device according to yet another embodiment of the present invention;

FIG. 13A is an oblique view of a yoke and magnets included in the linear motor that drives the second lens group frame unit in FIG. 12; and

FIG. 13B is a front view of the yoke and magnets in FIG. 13A as viewed in the optical axis direction.

### DETAILED DESCRIPTION OF THE EMBODIMENT

An embodiment will now be described in detail with reference to the drawings as needed. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

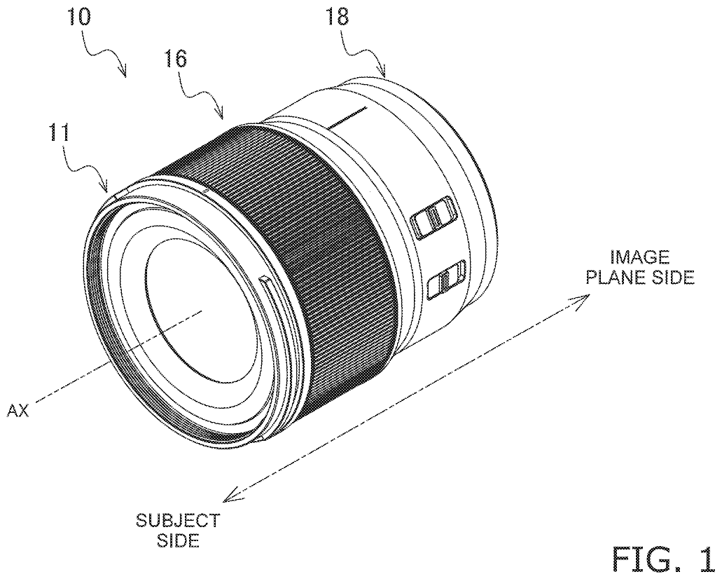

A lens drive device 20 and a lens barrel 10 comprising this lens drive device according to an embodiment of the present invention will now be described through reference to FIGS. 1 to 9.

### (1) Configuration of Lens Barrel 10

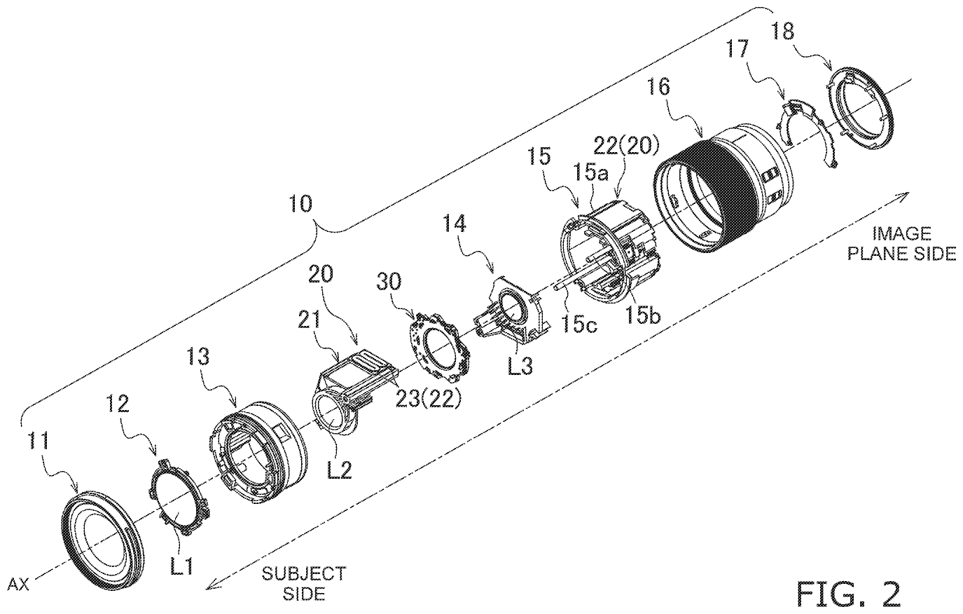

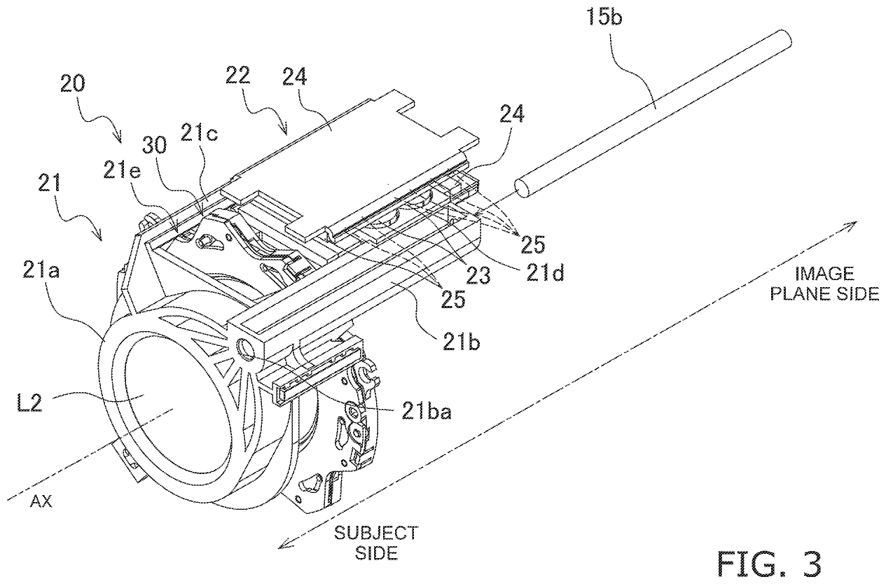

As shown in FIG. 1, the lens barrel 10 according to this embodiment has a substantially cylindrical shape, and is detachably attached to a camera body (not shown). As shown in FIG. 2, the lens barrel 10 comprises a filter frame unit 11, a first lens group frame unit 12, a front fixed frame unit 13, a lens drive device 20 (a second lens group frame unit 21, a linear motor 22 (see FIG. 3)), a third lens group frame unit 14, a rear fixed frame unit 15, an exterior unit 16, a circuit board unit 17, a lens mount unit 18, and an aperture unit 30.

The filter frame unit 11 is a substantially annular member that constitutes part of the external appearance of the lens barrel 10, and as shown in FIG. 1, is attached to the subject-side surface of the front fixed frame unit 13 so as to cover the subject-side surface in the optical axis AX direction of the first lens group frame unit 12.

As shown in FIG. 2, the first lens group frame unit 12 is a substantially annular member that holds a first lens group L1. The first lens group frame unit 12 is attached on the subject side in the optical axis AX direction of the substantially cylindrical front fixed frame unit 13. Also, the first lens group frame unit 12 is fixed inside the lens barrel 10.

As shown in FIG. 2, the front fixed frame unit 13 is a substantially cylindrical member, and the first lens group frame unit 12 is attached to the subject side in the optical axis AX direction. Also, the front fixed frame unit 13 is fixed inside the lens barrel 10.

The lens drive device 20 is configured to include the second lens group frame unit 21 and the linear motor 22, and is disposed on the inner peripheral surface side of the front fixed frame unit 13.

As shown in FIG. 2, the second lens group frame unit 21 holds a second lens group L2 and is driven back and forth in the optical axis AX direction by a linear motor 22 (discussed below).

The linear motor 22 drives the second lens group L2 and a frame body 21a back and forth in the optical axis AX direction by passing a current through coils 23 fixed on the frame body 21a, and switching the direction of the current.

The precise configuration of the lens drive device 20 including the second lens group frame unit 21 and the linear motor 22 will be described in detail below.

As shown in FIG. 2, the third lens group frame unit 14 holds a third lens group L3, and is driven back and forth in the optical axis AX direction.

As shown in FIG. 2, the rear fixed frame unit 15 is a substantially cylindrical member, and the third lens group frame unit 14 is driven back and forth in the optical axis AX direction. The rear fixed frame unit 15 has a main body portion 15a, a guide shaft 15b (main shaft), and a guide shaft 15c. The main body portion 15a is a substantially annular member, and the third lens group frame unit 14 is housed on the inner peripheral surface side thereof in a state of being movable in the optical axis AX direction.

The guide shaft 15b (main shaft) is disposed on the inner peripheral surface side of the main body portion 15a, and is disposed along the optical axis AX direction. The guide shaft 15b is inserted into a main bearing portion 21b (see FIG. 3) of the second lens group frame unit 21, and guides the second lens group frame unit 21 in the optical axis AX direction.

The guide shaft 15c is disposed on the inner peripheral surface side of the main body portion 15a on the opposite side from the guide shaft 15b, and is disposed along the optical axis AX direction.

The guide shaft 15c is inserted into the third lens group frame unit 14, and guides the third lens group frame unit 14 in the optical axis AX direction.

As shown in FIG. 2, the exterior unit 16 (housing portion) is a substantially cylindrical member that constitutes the exterior portion of the lens barrel 10, and encompasses the front fixed frame unit 13, the lens drive device 20, the third lens group frame unit 14, and the rear fixed frame unit 15. An annular focus ring or the like is attached to the outer peripheral surface of the exterior unit 16 so as to be rotatable around the circumferential direction.

As shown in FIG. 2, the circuit board unit 17 is attached to the end surface of the exterior unit 16 on the image plane side.

As shown in FIG. 2, the lens mount unit 18 is a substantially annular member attached to the end on the image plane side of the rear fixed frame unit 15, and is replaceably mounted to a mount portion of the camera body (not shown).

As shown in FIG. 2, the aperture unit 30 is a substantially annular member that drives movable blades to vary the surface area of the open portion and adjust the amount of light that passes through the lens portion of the lens barrel 10. Also, the aperture unit 30 is fixed on the inner peripheral surface side of the front fixed frame unit 13.

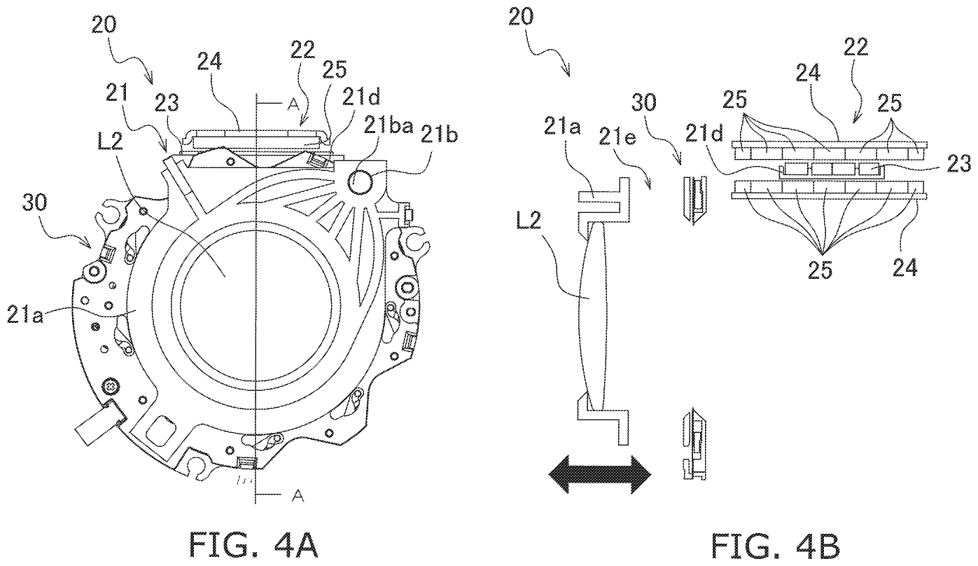

As shown in FIG. 4B, the aperture unit 30 is disposed along the optical axis AX direction of the second lens group L2, between the second lens group frame unit 21 and the third lens group frame unit 14 in the optical axis AX direction. Furthermore, the aperture unit 30 is fixed inside the lens barrel 10. The second lens group frame unit 21 is driven back and forth in the optical axis AX direction with respect to the aperture unit 30 by the linear motor 22.

As shown in FIG. 4A, the aperture unit 30 is disposed at a position overlapping the coils 23 in the radial direction centered on the optical axis AX of the second lens group L2. That is, the aperture unit 30 is disposed at a position overlapping the coils 23 when viewed in the optical axis AX direction. Also, as shown in FIG. 4B, the aperture unit 30 is provided between the second lens group L2 and the yokes 24 included in the linear motor 22.

### (2) Configuration of Lens Drive Device 20

As shown in FIGS. 3 and 4A, the lens drive device 20 of this embodiment comprises a second lens group frame unit 21 (lens frame) and a linear motor 22 (coils 23, yokes 24, and magnets 25).

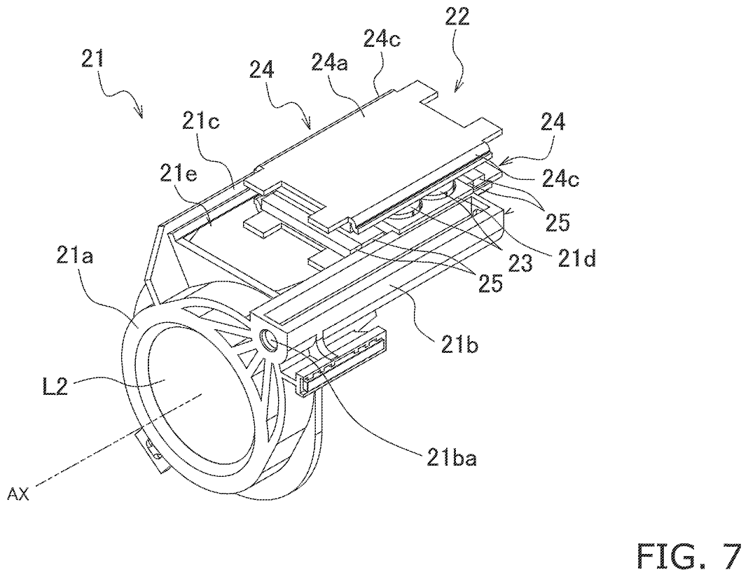

As shown in FIG. 7, the second lens group frame unit 21 has a frame body 21a that holds the second lens group L2, a main bearing portion 21b, a linking portion 21c, a coil mounting base 21d, and an open portion 21e.

As shown in FIG. 7, the second lens group L2 is attached to the frame body 21a. As shown in FIG. 7, the frame body 21a has a main bearing portion 21b disposed along the optical axis AX direction, a linking portion 21c provided approximately parallel to the main bearing portion 21b, and an open portion 21e formed between the main bearing portion 21b and the linking portion 21c.

As shown in FIG. 4B, the second lens group L2 is driven back and forth in the AX direction by the linear motor 22 while maintaining a positional relation in which the aperture unit 30 is sandwiched between the second lens group L2 and the coils 23 included in the linear motor 22 in the optical axis AX direction. The second lens group L2 is fixed to the first end side (the subject side in the optical axis AX direction) of the main bearing portion 21b of the frame body 21a.

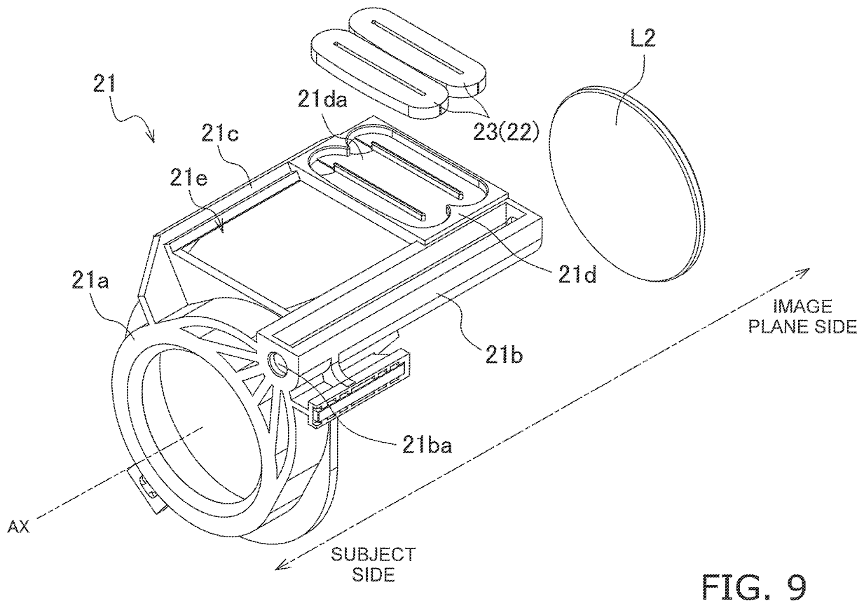

Also, the second lens group L2 is attached to the frame body 21a of the second lens group frame unit 21 from the image plane side in the optical axis AX direction (see FIG. 9).

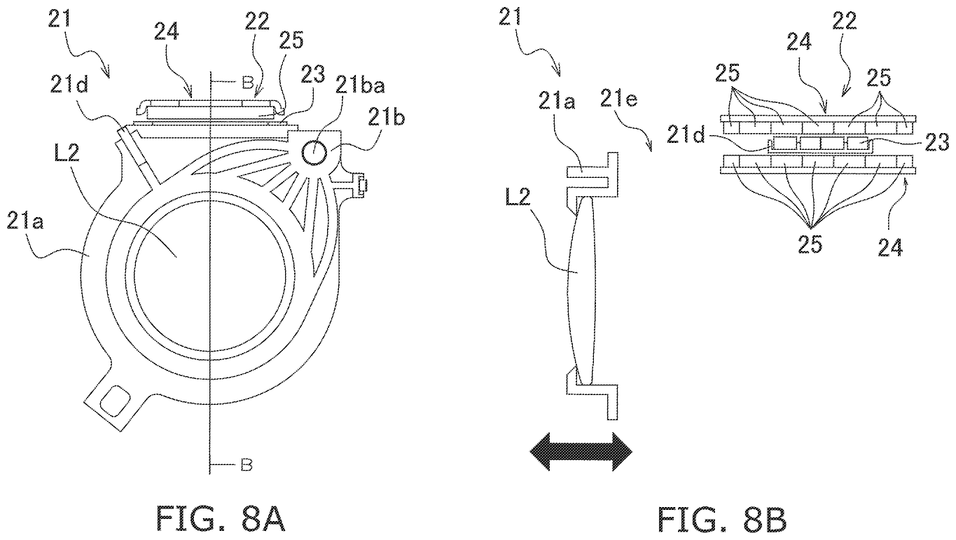

As shown in FIGS. 7 and 8A, the main bearing portion 21b has an insertion hole 21ba into which is inserted a guide shaft 15b that guides the frame body 21a in the direction of the optical axis AX. Consequently, as shown in FIG. 8B, the second lens group frame unit 21 is driven back and forth in the optical axis AX direction by the linear motor 22 in a state of being guided in the optical axis AX direction by the guide shaft 15b.

As shown in FIG. 9, the linking portion 21c is a flat portion disposed approximately parallel to the main bearing portion 21b, and links the upper portion of the frame body 21a where the second lens group L2 is provided, to the portion where the coils 23 is provided (the coil mounting base 21d), in the optical axis AX.

Consequently, in a configuration in which the coils 23 are disposed at a location that is away from the second lens group L2 in the optical axis AX direction, rigidity can be increased between the frame body 21a and the portion where the coils 23 are mounted (the coil mounting base 21d). This effectively suppresses vibration that is produced when the second lens group frame unit 21 is driven in the optical axis AX direction by the linear motor 22.

As shown in FIG. 9, the coil mounting base 21d is a base on which two coils 23 are placed, and links the main bearing portion 21b and the linking portion 21c in a direction perpendicular to the optical axis AX direction. A concave coil holding portion 21da formed to match the shape of the two coils 23 is provided to the coil mounting base 21d.

As shown in FIG. 9, the coil holding portion 21da has a concave shape in which two ovals are connected in the transverse direction so that the two coils 23 fit therein. This makes it easy to position the two coils 23 disposed on the coil mounting base 21d.

As shown in FIG. 9, the open portion 21e is formed between the frame body 21a and the coil mounting base 21d, and between the main bearing portion 21b and the linking portion 21c. That is, the open portion 21e is a substantially rectangular opening, and is formed so that its four sides are surrounded by the frame body 21a, the coil mounting base 21d, the main bearing portion 21b, and the linking portion 21c.

A part of the aperture unit 30 is inserted into the open portion 21e (see FIGS. 3 and 4B). Consequently, the second lens group frame unit 21 is driven back and forth in the optical axis AX direction by the linear motor 22 with respect to the aperture unit 30 fixed inside the lens barrel 10. The linear motor 22 has the coils 23, the yokes 24, and a plurality of unipolar magnetized magnets 25, as shown in FIGS. 3A and 4B.

As shown in FIG. 4B, the coils 23 are attached to the coil mounting base 21d of the frame body 21a, and are disposed so as to sandwich the aperture unit 30 between the coils and the second lens group L2 in the optical axis AX direction.

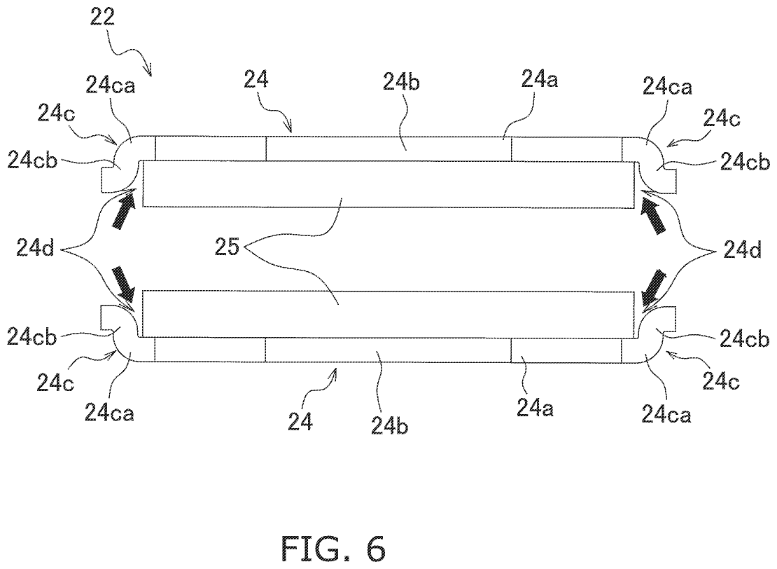

The yokes 24 are, for example, flat members made of iron, and are formed by stamping. As shown in FIGS. 4A and 4B, two yokes 24, upper and lower, are disposed substantially parallel to each other in the upper part of the second lens group frame unit 21, and the coil 23 is disposed between these. Also, as shown in FIG. 6, the magnets 25 are attached to the opposing surfaces of the two yokes 24.

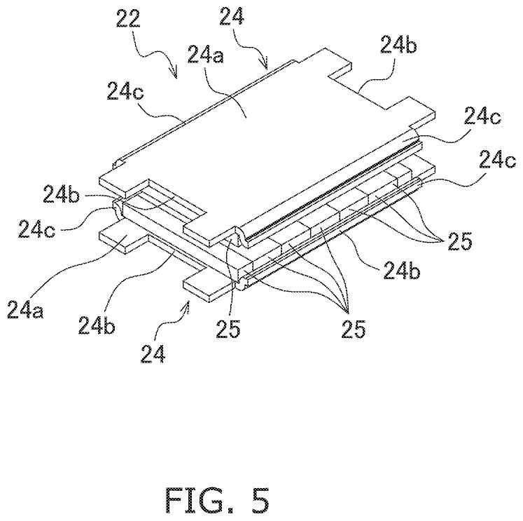

Also, as shown in FIGS. 5 and 6, the yokes 24 each include a main body portion 24a, recessed portions 24b, a bent end portion 24c (reinforcing portion), and injection portions 24d.

The main body portion 24a has a substantially cuboid shape, and the recessed portions 24b are formed at both ends in the optical axis AX direction. The bent end portions 24c, which increase the bending strength of the yoke 24 in the lengthwise direction, are provided at the end portions of the main body portion 24a in the width direction perpendicular to the optical axis AX direction.

The recessed portions 24b are cutout portions formed in the approximate center of both end surfaces of the main body portion 24a in the optical axis AX direction, and are attached in a state in which a part of the rear fixed frame unit 15 is engaged with the rear fixed frame unit 15.

This allows the yokes 24 to be easily positioned with respect to the rear fixed frame unit 15.

As shown in FIGS. 5 and 6, the bent end portions 24c (reinforced portions) are formed by bending the ends in the width direction (the left and right direction in the drawings) of the main body portion 24a perpendicular to the optical axis AX direction, and are provided along the optical axis AX direction in which the magnets 25 are provided (the lengthwise direction of the yokes 24). As shown in FIG. 6, the bent end portions 24c have a shape that is bent in two stages. More specifically, the bent end portions 24c each have a bent portion 24ca (first bent portion) that is the portion connected to the main body portion 24a, and a bent portion 24cb (second bent portion) that is bent further than the bent portion 24ca.

The bent portion 24ca is formed by bending the end portion of the main body portion 24a in the direction of the opposing surfaces of the yokes 24.

The bent portion 24cb is formed by further bending the distal end portion of the bent portion 24ca outward.

Consequently, the bent end portions 24c increase the bending strength of the yokes 24 in the lengthwise direction, which effectively suppresses warping. Also, the increased bending strength provided by the bent end portions 24c allows the yokes 24 to be made thinner to the extent that magnetic saturation does not occur, which in turn allows the lens drive device 20 and the lens barrel 10 to be smaller and lighter.

As shown in FIG. 6, the injection portions 24d are gaps (indicated by the black arrows in the drawings) formed between the bent end portions 24c and the end surfaces of the magnets 25 in the lengthwise direction, into which is injected an adhesive agent for fixing the magnets 25 to the opposing faces of the yokes 24.

The magnets 25 are, for example, neodymium-based sintered magnets, are magnetized so that the side touching the yoke 24 is an S pole and the opposite side is an N pole, and are fixed to the opposing surfaces of the two yokes 24 as shown in FIGS. 5 and 6. The plurality of magnets 25 are disposed so that their lengthwise direction is perpendicular to the optical axis AX direction.

Also, as shown in FIG. 6, the magnets 25 are attached between the bent end portions 24c provided at both ends in the width direction (left and right direction in the drawings) of the yokes 24.

Consequently, in attaching the magnets 25 to the opposing surfaces of the yokes 24, the magnets 25 can be more easily positioned.

Also, since the side surfaces in the width direction of the magnets 25 are covered by the bent end portions 24c of the yokes 24, magnetic flux leakage in the width direction of the magnets 25 can be suppressed. This prevents the magnetic sensors or the like provided inside the lens barrel 10 from being adversely affected, for example.

Furthermore, the magnets 25 are fixed to the yokes 24 by an adhesive agent that is injected into the gaps (injection portions 24d) formed between the end faces in the lengthwise direction and the bent end portions 24c.

Consequently, the adhesive agent injected into the gaps of the injection portions 24d is held in the gap by surface tension, and penetrates through the gaps into the interior, which allows the magnets 25 to be fixed more securely to the yokes 24.

As shown in FIG. 9, the two coils 23 are fixed on a second end side (image plane side in the optical axis AX direction) that is on the opposite side from the first end of the main bearing portion 21b of the frame body 21a (subject side in the optical axis AX direction). More specifically, the two coils 23 are disposed on the coil mounting base 21d provided to the frame body 21a on the image plane side in the optical axis AX direction.

Consequently, when current is sent through the two coils 23, the coils 23 are subjected to Lorentz force from the magnets 25 disposed above and below, and are driven in the optical axis AX direction.

### Main Features

As shown in FIG. 7, the lens drive device 20 of this embodiment comprises the second lens group frame unit 21, the n-phase (n is an integer of 2 or more) coils 23, the plurality of magnets 25, and the plurality of yokes 24. The second lens group frame unit 21 holds the second lens group L2, which is driven in the optical axis AX direction. The coils 23 are provided to the second lens group frame unit 21. The magnets 25 are disposed opposite the coils 23. The yokes 24 have the plurality of magnets 25 disposed along the optical axis AX direction so as to sandwich the coils 23, and have the bent end portions 24c provided along the lengthwise direction to increase rigidity in the lengthwise direction.

Providing the bent end portions 24c increases the bending strength of the yokes 24 in the lengthwise direction, which means that warping caused by magnetic attraction force can be effectively suppressed.

Also, increasing the bending strength of the yokes 24 allows the wall thickness of the yokes 24 to be thinner than in the past. Consequently, adequate bending strength can be ensured while making the yoke 24 thin enough to prevent magnetic saturation.

As a result, the yokes can be made thin enough to avoid magnetic saturation while still ensuring adequate bending strength against magnetic attraction force, so the product can be smaller and lighter in weight.

### Embodiment 2

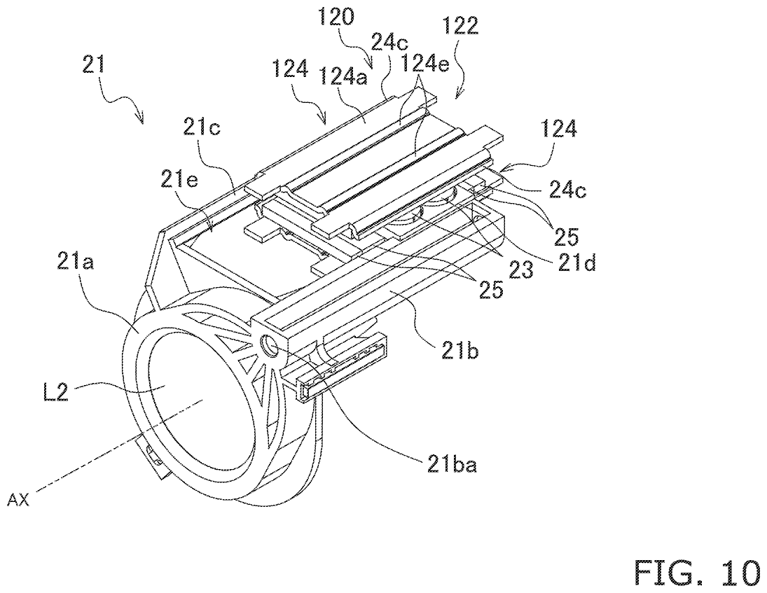

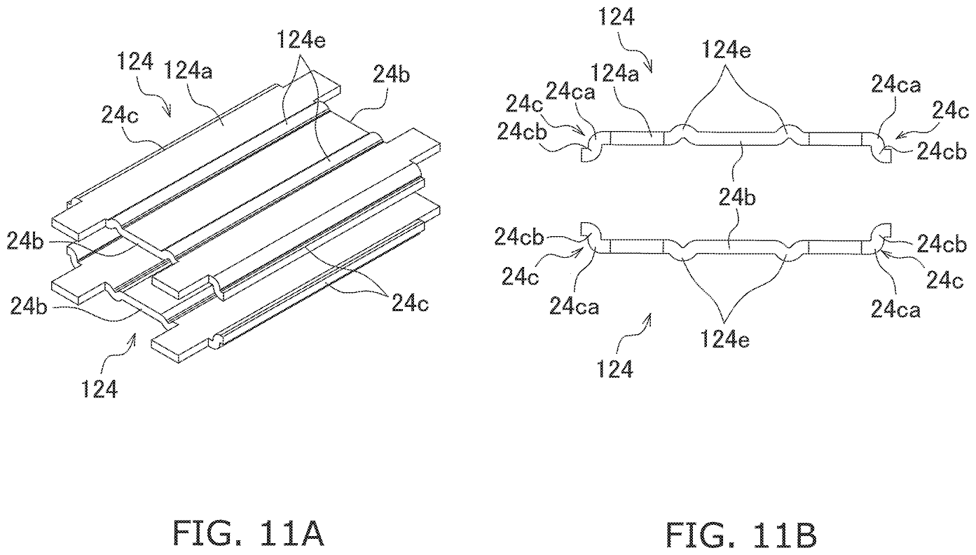

A lens drive device 120 according to another embodiment of the present invention will now be described through reference to FIGS. 10 to 11B.

As shown in FIG. 10, the lens drive device 120 of this embodiment differs from Embodiment 1 described above in that the yokes 124 included in the linear motor 122 include center bent portions 124e in addition to the bent end portions 24c provided at both ends in the width direction.

The rest of the configuration is the same as in Embodiment 1, so in this embodiment components that are the same will be numbered the same and will not be described in detail again.

As shown in FIGS. 11A and 11B, the center bent portions 124e are formed such that the area near the approximate center in the width direction of the flat main body portion 124a of each yoke 124 (the left and right direction in FIG. 11B) is bent along the lengthwise direction of the yoke 124.

Also, two center bent portions 124e are provided in left and right symmetry with respect to the center in the width direction of the main body portion 124a of the yoke 124.

As mentioned above, the lens drive device 120 of this embodiment includes a linear motor 122 including the yokes 124, in which the center bent portions 124e are added to the configuration of the yokes 24 in Embodiment 1.

Consequently, the bending strength of the yoke 124 in the lengthwise direction can be further increased as compared to the yokes 24 in Embodiment 1.

This means that the yokes can be made thin enough to avoid magnetic saturation while ensuring adequate bending strength against magnetic attraction force, so the product can be smaller and lighter in weight.

### Embodiment 3

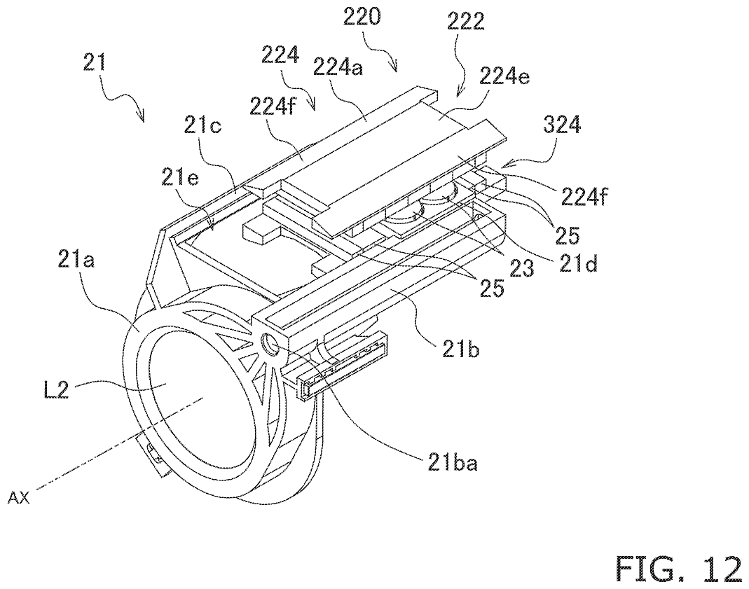

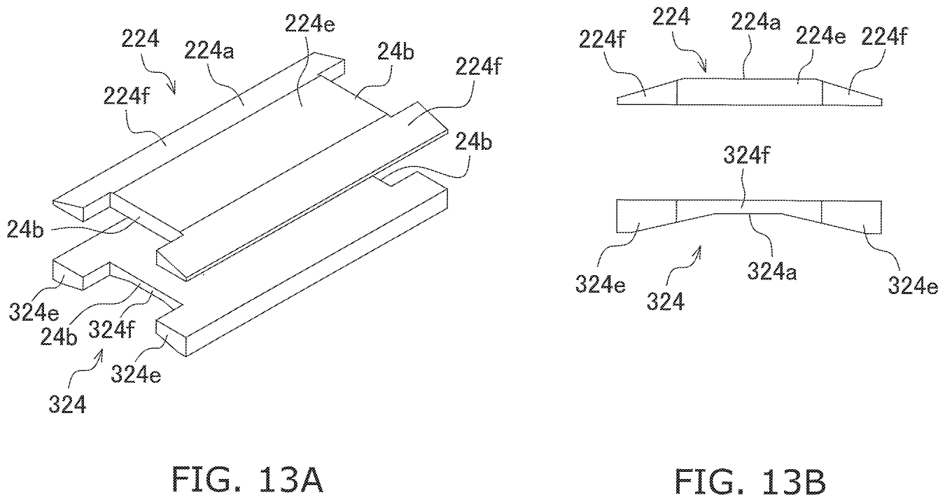

A lens drive device 220 according to yet another embodiment of the present invention will now be described through reference to FIGS. 12 to 13B.

As shown in FIG. 12, the lens drive device 220 of this embodiment differs from Embodiments 1 and 2 above in that a linear motor 222 is provided that has yokes 224 and 324 including thick portions 224e and 324e whose thickness is different in the width direction as reinforcing portions, instead of the yokes 24 of Embodiment 1 above.

The rest of the configuration is the same as that in Embodiments 1 and 2, so in this embodiment, those components will be numbered the same and will not be described again in detail.

The lens drive device 220 in this embodiment has a yoke 324 (first yoke portion) disposed near the third lens group frame unit 14 on the radially inner side centered on the optical axis AX, and a yoke 224 (second yoke portion) disposed at a position facing the opposite side of the second lens group frame unit 21 of the second lens group relative to the yoke 324 with respect to the yoke 324.

As shown in FIG. 13A, etc., the yokes 224 and 324 are disposed substantially parallel to each other in the up and down direction in the drawing.

The yoke 224 is configured to have a substantially peaked shape when viewed from the front, as shown in FIGS. 13A and 13B. The yoke 224 has a thick portion 224e (second thick portion) provided in the approximate center in the width direction (the left and right direction in the drawing) of the main body portion 224a, and thin portions 224f provided at both ends thereof.

The thick portion 224e (second thick portion) is formed such that its thickness at the center portion in the width direction of the yoke 224 opposite the yoke 324 is greater than that at both ends in the width direction.

The thin portions 224f are formed such that the outer surface in the radial direction centered on the optical axis AX direction becomes thinner going from the connection portions with the thick portions 224e toward both ends.

Consequently, adequate bending strength of the yoke 224 can be ensured in the lengthwise direction by the thick portion 224e provided at the center portion in the width direction, and a reduction in thickness is achieved by the thin portions 224f provided at both ends thereof. This means that the yoke 224 can be prevented from interfering with other components inside the lens barrel 10, and the lens barrel 10 can be made smaller and lighter.

As shown in FIGS. 13A and 13B, the yoke 324 is configured such that the approximate center in front view is thinner. The yoke 324 has a thin portion 324f provided in the approximate center in the width direction of the main body portion 324a (the left and right direction in the drawing), and thick portions 324e (first thick portions) provided at both ends thereof.

The thick portions 324e (first thick portions) are provided to conform to the outer shape of the third lens group frame unit 14 at both ends in the width direction of the yoke 324 disposed near the third lens group frame unit 14, and are formed to be thicker than the center part.

The thin portion 324f is formed such that the lower surface of the side closer to the third lens group frame unit 14 becomes thinner going from the connection portion with the thick portions 324e toward the center.

Consequently, adequate bending strength of the yoke 324 can be ensured in the lengthwise direction by the thick portions 324e provided at both ends in the width direction, and the thin portion 324f provided at the center portion thereof affords a reduction in thickness. This means that the yoke 324 can be prevented from interfering with other components inside the lens barrel 10, such as the third lens group frame unit 14, and the lens barrel 10 can be made smaller and lighter.

### OTHER EMBODIMENTS

Embodiments of the present invention were described above, but the present invention is not limited to or by the above embodiments, and various changes are possible without departing from the gist of the disclosure.

### (A)

In Embodiment 1, an example was given in which the bent end portions 24c were provided as reinforcing portions to prevent warping in the lengthwise direction of the yokes 24, and in Embodiment 2, an example was given in which the center bent portions 124e were further provided in addition to the bent end portions 24c. However, the present invention is not limited to this.

For example, the configuration may be such that the main body portion is provided with only the center bent portion of Embodiment 2, and a yoke without bent end portions is included.

That is, the reinforcing portions provided to ensure adequate bending strength of the yokes may be not only bent end portions or a combination of bent end portions and a center bent portion, but also a yoke configuration in which only a center bent portion is provided.

### (B)

In Embodiment 1, an example was given in which the bent end portions 24c were provided at both ends in the width direction as reinforcing portions for preventing warping of the yokes 24 in the lengthwise direction. However, the present invention is not limited to this.

For example, the bent end portions provided as reinforcing portions may be provided at just one end, rather than at both ends in the width direction.

### (C)

In Embodiment 2, an example was given in which two center bent portions 124e were provided near the center in the width direction as reinforcing portions for preventing warping in the lengthwise direction of the yokes 124. However, the present invention is not limited to this.

For example, the position and number of center bent portions provided as reinforcing portions are not limited to what is given in Embodiment 2, and can be changed as needed.

### (D)

In the third embodiment, an example was given in which the yoke 224 having the thick portion 224e in the center in the width direction was combined with the yoke 324 having the thick portions 324e at the two ends in the width direction. However, the present invention is not limited to this.

For example, as long as the configuration includes a thick portion that is different in thickness from other parts in the width direction in order to ensure adequate bending strength in the lengthwise direction of the yokes, the shapes of the two yokes provided as a pair may be the same.

### (E)

In the above embodiment, an example was given in which two coils 23 included in the linear motor 22 were disposed on the coil mounting base 21d of the second lens group frame unit 21.

However, the present invention is not limited to this.

For example, the number of coils included in the linear motor may be just one, or may be three or more.

### (F)

In the above embodiment, an example was given in which the magnets 25 were provided on both sides of the coils 23. However, the present invention is not limited to this.

For example, even with a configuration in which the magnets are provided on just one side of the coils, there is the risk that an attractive force will act between the magnets and the yokes, causing warping in the lengthwise direction of the thinned yokes. Accordingly, the same effect as described above can be obtained by applying the present invention to a configuration in which the magnets are provided on just one side of the coils.

### (G)

In the above embodiment, an example was given in which the lens drive device 20 of the present invention was mounted on the lens barrel 10, which was used as an interchangeable lens that could be attached to and detached from a camera body. However, the present invention is not limited to this.

For example, the configuration of the present invention may be applied to a lens drive device that is included in a lens barrel that is permanently attached to a camera body.

### INDUSTRIAL APPLICABILITY

The lens drive device of the present invention exhibits the effect that a yoke can be made thin enough to prevent magnetic saturation while still ensuring adequate bending strength against magnetic attraction force, which allows the product to be smaller and lighter, and as such can be widely applied to various kinds of lens drive device.

### REFERENCE SIGNS LIST

10 lens barrel
11 filter frame unit
12 first lens group frame unit
13 front fixed frame unit
14 third lens group frame unit
15 rear fixed frame unit
15a main body portion
15b guide shaft
15c guide shaft
16 exterior unit (housing portion)
17 circuit board unit
18 lens mount unit
20 lens drive device
21 second lens group frame unit (lens frame)
21a frame body
21b main bearing portion
21ba insertion hole
21c linking portion
21d coil mounting base
21da coil holding portion
21e open portion
22 linear motor
23 coil
24 yoke
24a main body portion
24b recessed portion
24c bent end portion (reinforcing portion)
23ca bent portion (first bent portion)
24cb bent portion (second bent portion)
24d injection portion
25 magnet
30 aperture unit
120 lens drive device
122 linear motor
124 yoke
124a main body portion
124e center bent portion
220 lens drive device
222 linear motor
224 yoke (second yoke portion)
224a main body
224e thick portion (second thick portion)
224f thin portion
324 yoke (first yoke portion)
324a main body portion
324e thick portion (first thick portion)
324f thin portion
AX optical axis
L1 first lens group
L2 second lens group
L3 third lens group

1. A lens drive device, comprising:
a lens frame configured to hold a lens driven in an optical axis direction;
an n-phase coil (n is an integer of 2 or more) that is provided to the lens frame;
a plurality of magnets that are disposed opposite the n-phase coil; and
a plurality of yokes in which the plurality of magnets are provided along the optical axis direction and that are disposed so as to sandwich the coil, each yoke having a reinforcing portion that is provided along a lengthwise direction and is configured to improve rigidity in the lengthwise direction.

2. The lens drive device according to claim 1,
wherein the reinforcing portions are provided so as to extend along the optical axis direction in which the plurality of magnets are disposed.

3. The lens drive device according to claim 1,
wherein the reinforcing portions each include a bent end portion formed such that both ends in a width direction substantially perpendicular to the lengthwise direction of the yoke are bent along the lengthwise direction of the yoke.

4. The lens drive device according to claim 3,
wherein the bent end portion includes a first bent portion that is bent in a direction of a plane where the plurality of yokes are opposite each other, and a second bent portion in which a distal end portion of the first bent portion is bent further outward.

5. The lens drive device according to claim 4,
wherein the plurality of magnets are attached between the first bent portions provided at ends of the yokes in the width direction.

6. The lens drive device according to claim 5,
wherein the magnets are fixed to the yokes by an adhesive agent injected into a gap formed between end faces in the lengthwise direction and the bent end portions.

7. The lens drive device according to claim 1,
wherein the yokes each include a center bent portion formed so as to bend an approximate center of the yoke in a width direction along the lengthwise direction of the yoke.

8. The lens drive device according to claim 7,
wherein the center bent portion is provided in right and left symmetry around a center in the width direction of the yoke.

9. The lens drive device according to claim 1,
wherein the reinforcing portions each include a thick portion having a different thickness in a width direction of the yoke.

10. The lens drive device according to claim 9,
wherein the plurality of yokes each include a first yoke portion that is disposed near the lens frame on an inner peripheral surface side, and a second yoke that is disposed at a position facing the first yoke portion on an opposite side from the lens frame, and
the thick portion includes a first thick portion that is provided along an outer shape of the lens frame at both ends in the width direction of the first yoke portion disposed near the lens frame, and is thicker than a center portion in the width direction.

11. The lens drive device according to claim 10,
wherein the thick portion includes a second thick portion that is thicker than the two ends in the width direction at a center portion in the width direction of a second yoke portion opposite the first yoke portion disposed near the lens frame.

12. A lens barrel, comprising:
the lens drive device according to claim 1; and
a substantially cylindrical housing portion that contains the lens drive device.
